(19) United States
(12) Patent Application Publication
(10) Pub. No.: US 2026/0055871 A1
(43) Pub. Date: Feb. 26, 2026

(54) MOTOR VEHICLE WITH A LIGHTING DEVICE AND A CONDENSATION PROTECTION SYSTEM

(71) Applicant: HELLA GMBH & CO. KGAA, Lippstadt (DE)

(72) Inventor: Andreas Lintz, Lippstadt (DE)

(21) Appl. No.: 19/302,948

(22) Filed: Aug. 18, 2025

(30) Foreign Application Priority Data
Aug. 23, 2024 (DE) 102024124172.1

(51) Int. Cl. F21S 45/10; F21S 45/33; F21S 45/60

(52) U.S. Cl. CPC F21S 45/10; F21S 45/33; F21S 45/60

(57) ABSTRACT

The invention relates to a motor vehicle with a lighting device and a condensation protection system having a control unit and a condensation protection device which can be activated as required in order to prevent condensation from forming on the lighting device. The lighting device has a housing and a lens that closes an opening of the housing. A light source unit is arranged within an interior space enclosed by the housing and lens. The lens and/or housing is a plastic component. The control unit is configured to carry out the process steps of: determining or receiving status data related to a current temperature in the interior space, a current air humidity in the interior space, and a current humidity sorbed in and/or on the plastic component; determining of a condensation risk based on the status data; and activating the condensation protection device depending on the determined condensation risk.

### CROSS-REFERENCE TO RELATED APPLICATIONS

The present application claims the benefit of German Patent Application No. 10-2024-124-172.1, filed Aug. 23, 2024, the disclosure of which is incorporated by reference.

### FIELD OF THE INVENTION

The invention relates to a motor vehicle with a lighting device and a condensation protection system for the lighting device. In particular, the lighting device is a front headlight. The lighting device can also be a rear light, for example.

### BACKGROUND OF THE INVENTION

Lighting devices generally have an interior space enclosed by a housing and a lens, also known as a cover lens, wherein a light source unit is arranged in said interior space. A light source unit can, for example, have one or more LED light sources.

For the function of a lighting device, in particular a headlight, it is important that condensation, i.e. the condensation of water, on the surfaces of optical components, such as the lens, is avoided, as such condensation would have a negative effect on the light distribution generated by the lighting device. In addition, condensation has a negative effect on the visual appearance of the lighting device for an observer.

A wide variety of condensation protection systems are known from the state of the art in connection with lighting devices to prevent condensation formation and/or to remove existing condensation.

From DE19733000A1, for example, it is known to arrange a heating element close to a surface of an optical component so that it is always kept dry.

It is known from DE102006006099A1 to additionally provide drying agents by means of which the humidity content of the interior space air is limited.

It is known from DE102022123961A1 to operate a light source unit with an increased condensation protection output compared to a normal output intended for generating the specified light distribution.

It is known from DE102022123952A1 that the light source unit is switched off in accordance with a switch-off regulation, according to which at least some of the light sources of the light source unit are gradually switched off and/or dimmed within a condensation protection time in such a way that no condensation occurs on an inner side of the lens.

DE 102004047885B4 describes a device for de-icing and defrosting a headlight.

A vehicle lighting including a humidity management device is known from US 9 982 857 B2, wherein the humidity management device comprises an anti-humidity fan with a switch for activating and deactivating the anti-humidity fan, wherein a humidity sensor located inside the vehicle lighting and electrically connected to the switch is configured to detect a humidity level inside the vehicle lighting and to generate a high humidity signal when the humidity level inside the light is above a predefined threshold value.

A disadvantage of the condensation protection systems known from the state of the art is that they are often oversized in terms of their capacity or performance in order to reliably prevent condensation formation. Other condensation protection systems from the state of the art, such as the system known from US 9 982 857 B2, are controlled. However, the disadvantage of this is that only the current air humidity is taken into account, so that a high air exchange rate or drying capacity is required to reliably prevent condensation and/or a threshold value for the humidity content must be set low to reliably prevent condensation.

### SUMMARY OF THE INVENTION

The task of the present invention is to provide a motor vehicle with a lighting device and a condensation protection system for the lighting device that overcomes the aforementioned disadvantages.

This task is solved by the object of the current embodiments. The current embodiments relate to advantageous further developments.

The motor vehicle according to the invention is a motor vehicle with a lighting device and a condensation protection system for the lighting device, wherein the condensation protection system has a control unit and a condensation protection device which can be activated as required to prevent condensation from forming on the lighting device, wherein the lighting device has a housing and a lens, wherein the lens closes an opening of the housing, wherein a light source unit is arranged within an interior space enclosed by the housing and the lens, wherein the lens and/or the housing is a plastic component, wherein the control unit of the condensation protection system is configured to carry out the following process steps: determining or receiving status data, wherein the status data relate to at least a current temperature in the interior space of the lighting device, a current air humidity in the interior space of the lighting device and a current humidity sorbed in and/or on the plastic component; computer-aided determining of a condensation risk of the lighting device based on the determined or received status data; and activating the condensation protection device depending on the determined condensation risk.

By determining the condensation risk, in particular a future condensation risk, of the lighting device and activating the condensation protection device as required depending on the determined condensation risk, undesired condensation of the lighting device, in particular the lens, can be reliably prevented. By activating the condensation protection device depending on the determined condensation risk and thus only when required or when there is a condensation risk, condensation of the lighting device can be reliably prevented with low energy requirements and material costs, for example with regard to the amount of drying agent. It is particularly advantageous that the condensation risk is taken into account with regard to the humidity currently present in and/or on the plastic component. This is because the desorption of humidity from or out of the plastic component, which is triggered by a change in temperature, for example, is a major cause of condensation. In other words, the humidity content of the air in the interior space is significantly influenced by sorption and desorption of humidity in the plastic component or components or on the plastic component or components of the lighting device. For example, when the light source unit is switched off, the temperature of the lighting device usually drops and the plastic component absorbs humidity from the air inside the lighting device. On the other hand, when the light source unit is switched on, the temperature of the plastic component increases, causing the humidity absorbed in the plastic component and adsorbed on the surface of the plastic component to be desorbed and released into the air in the interior space, thereby increasing the air humidity in the interior space of the lighting device. This increase in air humidity or humidity content causes the condensation point to rise, which can lead to condensation forming on components or areas of the lighting device whose temperature is below the condensation point. It was recognized that the air humidity in the interior space of the lighting device is largely determined by the process of desorption and sorption of humidity by the plastic component(s). By taking into account the humidity currently sorbed in and/or on the plastic component as status data when determining the condensation risk, the condensation risk can be determined more reliably than would be the case if only the current humidity present in the air of the interior space were taken into account.

Since direct measurement of the humidity currently sorbed in and/or on the plastic component is generally difficult or impossible, it is considered particularly advantageous if the humidity sorbed in and/or on the plastic component is determined using a computer-assisted algorithm, in particular by means of the control unit. It is quite conceivable that the input variables for this algorithm for determining the humidity sorbed in and/or on the plastic component could be measurement data relating to the temperature in the interior space and measurement data relating to the air humidity in the interior space.

The term humidity of the air is used here to refer in particular to relative air humidity.

In particular, the lighting device is a front headlight.

In particular, the light source unit is a light source unit with LED elements.

Preferably, the lighting device has ventilation elements that allow air to be exchanged between the interior space of the lighting device and an environment. Such a ventilation element preferably has a membrane to prevent or at least limit the entry of dust and/or humidity from the environment into the interior space via the ventilation element.

In a particularly preferred embodiment, it is provided that determining a condensation risk of the lighting device is carried out using an algorithm stored in the control unit, wherein the algorithm includes a virtual thermal model of the lighting device. The use of a virtual thermal model of the lighting device has the advantage that temperatures of areas of the lighting device can be determined based on the status data and based on this it can be determined whether temperatures of areas are below the condensation point or will be in the future, whereby the condensation risk for these areas can be determined. If the control unit determines that there is a condensation risk in areas of the lighting device if the temperature of areas of the lighting device, for example the lens, is or is likely to be below the condensation point, the condensation protection device can be activated.

It is considered particularly advantageous if the determined condensation risk relates to a future condensation risk, possibly in addition to a current condensation risk. A future condensation risk can be determined in particular by taking into account not only the current air humidity in the interior space as status data for determining the condensation risk, but also status data relating to the humidity sorbed in and/or on the plastic component. As already explained, this humidity can desorb if there is a temperature rise in the plastic component or a temperature rise in the interior space of the lighting device. As a result of desorption, the humidity of the air in the interior space can rise sharply or even abruptly. This increases the risk of areas of the lighting device having a temperature below the condensation point, which can lead to condensation in these areas. A rise in temperature can be caused, for example, by switching on the light source unit. Against this background in particular, it is considered especially advantageous if the control unit is configured to determine the condensation risk assuming a change in the operating state of the light source unit.

In this context, it is again considered particularly advantageous if the control unit contains a virtual thermal model of the lighting device. In this way, it can be particularly reliably determined how the temperature of the plastic components changes when the light source unit is switched on or off.

In a particularly preferred embodiment, it is provided that the control unit is configured to receive expected values for an outside temperature via a communication link, wherein the condensation risk of the lighting device is additionally determined based on the expected values for the outside temperature. The expected values for the outside temperature can, for example, be stored in a data storage external to the vehicle, such as a server, and transmitted to the control unit via a wireless communication link.

It is considered to be particularly advantageous if the lighting device has a humidity sensor, wherein the humidity sensor is configured to measure the current air humidity or the humidity content of the air in the interior space of the lighting device, wherein the humidity sensor is communicatively connected to the control unit, wherein the control unit is configured to receive the current air humidity in the interior space of the lighting device measured by the humidity sensor as one of the status data.

Furthermore, it is considered particularly advantageous if the lighting device has a temperature sensor, wherein the temperature sensor is configured to measure a temperature in the interior space of the lighting device, wherein the temperature sensor is communicatively connected to the control unit, wherein the control unit is configured to receive the temperature measured by the temperature sensor as one of the status data.

In an advantageous further development, it is provided that the control unit is configured to determine, in a computer-assisted manner, the humidity currently sorbed in and/or on the plastic component using a sorption behavior of the plastic component and desorption behavior of the plastic component stored in the control unit and based on previous values for the air humidity in the interior space measured by the humidity sensor and/or based on previous values for the interior space temperature measured by the temperature sensor. In this context, it is considered particularly advantageous if the absorption and desorption of humidity by the plastic component and the associated influence on the air humidity prevailing in the interior space is calculated by the control unit using an algorithm, wherein this algorithm is designed as a self-learning algorithm. It is quite conceivable that the values calculated by the self-learning algorithm for the air humidity in the interior space are compared with the values measured by the humidity sensor for the air humidity in the interior space. Based on the result of the comparison, the algorithm can then be automatically corrected if necessary in order to improve this algorithm.

It is considered particularly advantageous if the motor vehicle has an outside temperature sensor, wherein the outside temperature sensor is configured to measure an outside temperature in the environment of the motor vehicle, wherein the outside temperature sensor is communicatively connected to the control unit, wherein the control unit is configured to receive the outside temperature measured by the outside temperature sensor as one of the status data. In particular, the outside temperature has an influence on the temperature of the lens, so that a temperature of the lens, in particular of different areas of the lens, can be determined based on the outside temperature in order to determine the condensation risk for the lens more reliably.

In a particularly preferred embodiment, it is provided that the control unit is configured to determine the condensation risk using a reduced order model for the lighting device. Such a model has the advantage that the computing power requirements of a processor are relatively low in order to perform a calculation of the condensation risk in real time on a processor of the control unit.

The model used to determine the condensation risk of the lighting device may be a model based on artificial intelligence, such as neural networks.

It is considered particularly advantageous if the condensation protection device comprises one or more of the following: an activatable heating device for heating the lighting device; an activatable first ventilation device, wherein when the first ventilation device is active, an air exchange is effected between the interior space and the surroundings of the motor vehicle; an activatable second ventilation device, wherein when the second ventilation device is active, an air exchange is effected between an air conditioning device, wherein the air conditioning device serves to air condition a motor vehicle interior; an activatable ventilation device, wherein when the ventilation device is active, an air exchange is effected between an air conditioning device, wherein the air conditioning device serves to air condition an air flow introduced into a motor vehicle interior; an activatable drying device, wherein the drying device contains a drying agent and, when the drying device is active, the drying agent is in contact with the air in the interior space in order to remove humidity from the air.

An air exchange with an air conditioning device is particularly advantageous in that the air conditioning device generates conditioned, e.g. cooled and/or dehumidified air, and this conditioned air can then be supplied to the interior space of the lighting device via the ventilation device. It is considered particularly advantageous if the air conditioning device has a refrigerant circuit to cool the air flow introduced into the vehicle interior. Preferably, the air conditioning device has a dehumidifying device for dehumidifying the air flow introduced into the vehicle interior. Preferably, a partial flow is diverted from the air flow and supplied to the interior space of the lighting device when the ventilation device is activated.

It is considered particularly advantageous if the condensation protection system is in operation regardless of the operating state of the motor vehicle. This makes it possible to activate the condensation protection device even when the motor vehicle is not in operation. It is conceivable, for example, that the motor vehicle is parked overnight and therefore not in use. The temperature drops overnight, which also lowers the temperature of the lighting device and leads to an increase in humidity sorbed in and/or on the plastic component. If the temperature of the lighting device then rises, for example when the light source unit is switched on, this humidity desorbs again and undesirable condensation could form on the lighting device. This condensation risk can be determined in advance via the control unit and the condensation protection device can be activated in advance. This can prevent condensation from occurring in the first place, for example when the light source unit is switched on, instead of only initiating appropriate countermeasures when condensation occurs, such as additional heating of the lens in order to eliminate the condensation that has already occurred.

In this respect, the invention is particularly aimed at preventing the occurrence of condensation in advance by activating the condensation protection device instead of eliminating condensation that has already occurred.

### BRIEF DESCRIPTION OF THE DRAWINGS

In the following figures, the invention is explained in more detail by means of an exemplary embodiment, without being limited to this. In the figures:

FIG. 1 is a schematic representation of a motor vehicle in a front view according to an embodiment of the invention; and

FIG. 2 is a schematic representation of a lighting device of the motor vehicle and a condensation protection system for the lighting device.

### DETAILED DESCRIPTION OF THE CURRENT EMBODIMENT

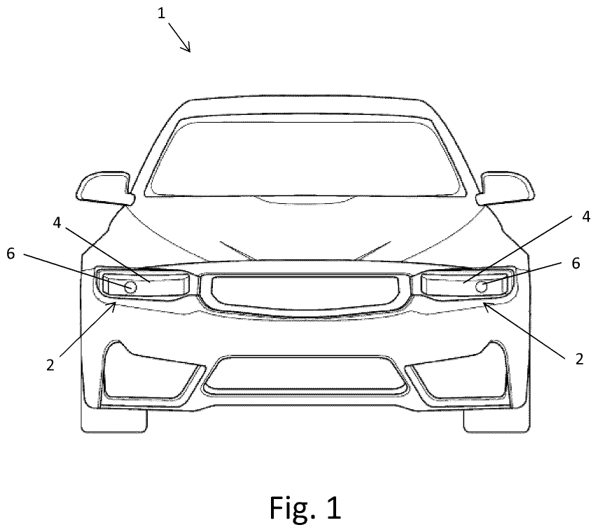

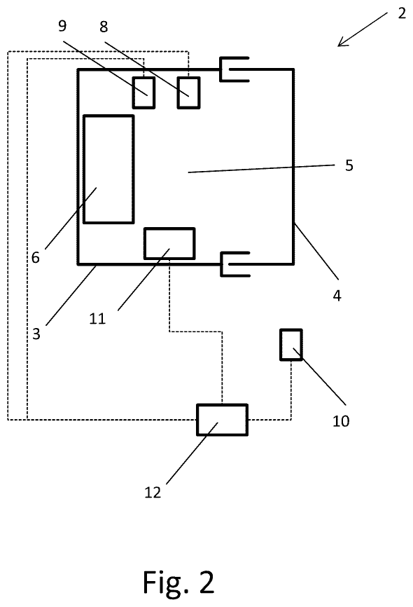

FIG. 1 shows a front view of a motor vehicle 1. The motor vehicle 1 has two lighting devices 2 arranged in the front area, wherein the respective lighting device 2 in this case is a headlight. The lighting devices 2 are identical. A single lighting device 2 as such is shown schematically in FIG. 2.

The respective lighting device 2 has a housing 3 and a lens 4. The lens 4 is often referred to as a cover lens in connection with a headlamp. The lens 4 closes an opening in the housing 3. Both the lens 4 and the housing 3 of the respective lighting device 2 are plastic components. The housing 3 and the lens 4 enclose an interior space 5 of the respective lighting device 2. Preferably, the lighting device 2 has one or more ventilation elements, via which an exchange of air between the interior space 5 of the lighting device 2 and an environment is made possible. A light source unit 6 is arranged in the enclosed interior space 5, which is configured to emit light when switched on in order to illuminate a space in front of the motor vehicle 1. The lighting device 2 can also include imaging optics, such as lenses. These are not shown for reasons of clarity.

The motor vehicle 1 has a condensation protection system for the respective lighting device 2. The condensation protection system comprises a control unit 12 and a condensation protection device 11 that can be activated as required, wherein the condensation protection device 11 is arranged in the enclosed interior space 5. The condensation protection device 11 can, for example, be an activatable heating device for heating the lighting device 2. The condensation protection system serves to prevent condensation on the lighting device 2, for example by lowering the relative air humidity in the interior space 5 of the lighting device 2 by activating the condensation protection device 11.

The control unit 12 is an electronic control unit 12 with a processor for executing a computer program. The control unit 12 of the condensation protection system is configured to carry out the following process steps: determining or receiving status data, wherein the status data relate to at least a current temperature in the interior space 5 of the lighting device 2, a current air humidity in the interior space 5 of the lighting device 2 and a current humidity sorbed in and/or on the plastic component; computer-aided determining of a condensation risk of the lighting device 2 based on the determined or received status data; activating the condensation protection device 11 depending on the determined condensation risk.

In order to measure the current air humidity in the interior space 5 of the lighting device 2 and to transmit the measured value to the control unit 12, the lighting device 2 has a humidity sensor 8, wherein the humidity sensor 8 is configured to measure the current air humidity in the interior space 5 of the lighting device 2. The humidity sensor 8 is communicatively connected to the control unit 12. The control unit 12 is configured to receive the current air humidity in the interior space 5 of the lighting device 2 measured by the humidity sensor 8 as one of the status data relating to the air humidity.

Furthermore, the lighting device 2 has a temperature sensor 9, wherein the temperature sensor 9 is configured to measure a current temperature in the interior space 5 of the lighting device 2. The temperature sensor 9 is communicatively connected to the control unit 12. The control unit 12 is configured to receive the temperature measured by the temperature sensor 9 as one of the status data relating to the temperature in the interior space 5.

The motor vehicle 1 has an outside temperature sensor 10, wherein the outside temperature sensor 10 is configured to measure an outside temperature in the environment of the motor vehicle 1. The outside temperature sensor 10 is communicatively connected to the control unit 12. The control unit 12 is configured to receive the outside temperature measured by the outside temperature sensor 10 as one of the status data.

The computer-aided determining of the condensation risk can be based on a physics-based model or a data-based model. The data-based model may have been created using artificial intelligence in particular.

### LIST OF REFERENCE NUMBERS

1 motor vehicle
2 lighting device
3 housing
4 lens
5 interior space
6 light source unit
8 humidity sensor
9 temperature sensor
10 outside temperature sensor
11 condensation protection device
12 control unit

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A motor vehicle comprising:
a lighting device; and
a condensation protection system for the lighting device, wherein the condensation protection system has a control unit and a condensation protection device which can be activated as required in order to prevent condensation from forming on the lighting device;
wherein the lighting device has a housing and a lens;
wherein the lens closes an opening of the housing;
wherein a light source unit is arranged within an interior space enclosed by the housing and the lens;
wherein at least one of the lens and the housing is a plastic component; and
wherein the control unit of the condensation protection system is configured to:
determine or receive status data, wherein the status data relate to at least a current temperature in the interior space of the lighting device, a current air humidity in the interior space of the lighting device and a current humidity sorbed in and/or on the plastic component;
determine a condensation risk of the lighting device based on the determined or received status data; and
activate the condensation protection device depending on the determined condensation risk.

2. The motor vehicle according to claim 1, wherein determining the condensation risk of the lighting device is carried out using an algorithm stored in the control unit, wherein the algorithm includes a virtual thermal model of the lighting device.

3. The motor vehicle according to claim 1, wherein the control unit is configured to determine the condensation risk assuming a change in an operating state of the light source unit.

4. The motor vehicle according to claim 1, wherein the control unit is configured to receive expected values for an outside temperature via a communication link, wherein the determination of the condensation risk of the lighting device is additionally based on the expected values for the outside temperature.

5. The motor vehicle according to claim 1, wherein the lighting device has a humidity sensor, wherein the humidity sensor is configured to measure the current air humidity in the interior space of the lighting device, wherein the humidity sensor is communicatively connected to the control unit, wherein the control unit is configured to receive the current air humidity measured by the humidity sensor in the interior space of the lighting device as one of the status data.

6. The motor vehicle according to claim 5, wherein the control unit is configured to determine the current humidity sorbed in and/or on the plastic component using a sorption behavior of the plastic component and desorption behavior of the plastic component stored in the control unit and based on previous values for the air humidity in the interior space measured by the humidity sensor.

7. The motor vehicle according to claim 5, wherein the lighting device has a temperature sensor, wherein the temperature sensor is configured to measure the current temperature in the interior space of the lighting device, wherein the temperature sensor is communicatively connected to the control unit, wherein the control unit is configured to receive the current temperature measured by the temperature sensor as one of the status data.

8. The motor vehicle according to claim 7, wherein the control unit is configured to determine the current humidity sorbed in and/or on the plastic component using a sorption behavior of the plastic component and desorption behavior of the plastic component stored in the control unit and based on previous values for the air humidity in the interior space measured by the humidity sensor and based on previous values for the temperature in the interior space measured by the temperature sensor.

9. The motor vehicle according to claim 1, wherein the lighting device has a temperature sensor, wherein the temperature sensor is configured to measure the current temperature in the interior space of the lighting device, wherein the temperature sensor is communicatively connected to the control unit, wherein the control unit is configured to receive the current temperature measured by the temperature sensor as one of the status data.

10. The motor vehicle according to claim 9, wherein the control unit is configured to determine the current humidity sorbed in and/or on the plastic component using a sorption behavior of the plastic component and desorption behavior of the plastic component stored in the control unit and based on previous values for the temperature in the interior space measured by the temperature sensor.

11. The motor vehicle according to claim 1, wherein the motor vehicle has an outside temperature sensor, wherein the outside temperature sensor is configured to measure an outside temperature in an environment of the motor vehicle, wherein the outside temperature sensor is communicatively connected to the control unit, wherein the control unit is configured to receive the outside temperature measured by the outside temperature sensor as one of the status data.

12. The motor vehicle according to claim 1, wherein the control unit is configured to determine the condensation risk using a reduced order model for the lighting device.

13. The motor vehicle according to claim 1, wherein the condensation protection device comprises at least one of:
an activatable heating device for heating the lighting device;
an activatable first ventilation device, wherein when the first ventilation device is active, an air exchange is effected between the interior space and the surroundings of the motor vehicle;
an activatable second ventilation device, wherein when the second ventilation device is active, an air exchange is effected between an air conditioning device, wherein the air conditioning device serves to air condition an air flow introduced into a motor vehicle interior; and
an activatable drying device, wherein the drying device contains a drying agent and, when the drying device is active, the drying agent is in contact with the air in the interior space in order to remove humidity from the air.

14. The motor vehicle according to claim 1, wherein the condensation protection system is in operation independently of an operating state of the motor vehicle.
